(19) United States
(12) Patent Application Publication
(10) Pub. No.: US 2026/0271907 A1
(43) Pub. Date: Sep. 17, 2026

(54) INSECT TRAP

(71) Applicant: Michael Davydov, Montclair, NJ (US)

(72) Inventor: Michael Davydov, Montclair, NJ (US)

(21) Appl. No.: 19/077,732

(22) Filed: Mar. 12, 2025

(51) Int. Cl. A01M 1/10

(52) U.S. Cl. CPC A01M 1/106; A01M 2200/012

(57) ABSTRACT

An insect trap includes a trapping chamber, a passageway, and an apron. The passageway has a proximal hole and a distal hole, with the apron attached to the proximal hole and the distal hole defining an entry into the chamber. The proximal hole has a longest cross-diameter that is larger than the longest cross-diameter of the distal hole. Insects contact the apron and move through the passageway into the trapping chamber where they become trapped. The trap is particularly suited for capturing spotted lanternflies and may be hung outside or affixed to natural or manufactured structures.

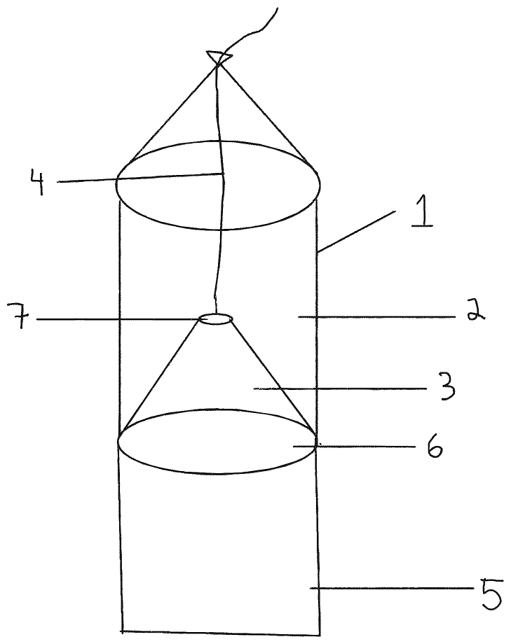

### BACKGROUND OF THE INVENTION

Insect infestation is a major social problem from a human health, environmental and economic perspective. One particular problem is the proliferation of spotted lanternflies due to their destructive feeding habits. Spotted lanternflies suck sap from a wide variety of plants, causing significant damage to crops and trees and leave behind a sticky substance that promotes sooty mold growth, and attracts other insects. This impacts agricultural production and outdoor enjoyment. This invasive species easily spreads due to their ability to latch on to vehicles and people.

There exists a need in the art to trap and reduce the populations of insects such as the spotted lanternfly.

### OBJECTS AND SUMMARY

It is an object of certain embodiments of the present invention to provide a trap for catching insects such as the spotted lanternfly.

It is an object of certain embodiments of the present invention to provide a trap that does not require bait for catching insects such as the spotted lanternfly.

It is an object of certain embodiments of the present invention to provide a method of trapping insects such as the spotted lanternfly with a trap as disclosed herein.

One or more of the above objects and others may be met by the present invention which in certain embodiments is directed to a trap for catching insects comprising a trapping chamber, a passageway and an apron, the passageway comprising a proximal hole and a distal hole, wherein the apron is adapted to receive insects and is attached to the proximal hole and the distal hole defines an entry into the chamber and is adapted to allow the insects to enter the chamber, wherein the proximal hole has a longest cross-diameter that is larger than the longest cross-diameter of the distal hole.

### BRIEF DESCRIPTION OF THE FIGURE

The Fig. shows an exemplary embodiment of the invention.

### DETAILED DESCRIPTION

The chamber can be any shape, e.g., cylindrical, bulbish, conical etc. and can be made of any bendable material, e.g., mesh or plastic. The passageway provides a point of entry from the external environment of the chamber to the interior environment of the chamber. In one embodiment, the passageway is conical or funnel shaped with a wider and a more narrow opening defining each end and extends into the interior of the chamber. The wider diameter opening acts as an entryway for the bugs with the wider diameter providing easier access for the insects. The more narrow opening of the passageway allows for entry into the interior of the chamber and due to the reduced diameter minimizes escape of the insects once entrapped in the chamber. Due to the bendable nature of the passageway, the narrower end is held upright by a flexible or inflexible string, wire, or combination thereof, tied to or through the top of the trap structure. The apron extends from the passageway and leads the insects into the chamber via the passageway. The apron is planar to allow the insects to land and crawl thereon. This is preferable to an apron that may just have an opening (e.g., a cylindrical shape) to provide access to insects. The planar structure provides more open air surface area where insects can land and the walk into the chamber through the passageway. The apron can be bendable in order to conform to a surface such as a tree trunk or other outdoor structure or object that the trap is placed. The apron may have a textured surface (e.g., a mesh material) to provide traction for the insects.

In certain embodiments, the trap (1) for catching insects comprising a trapping chamber (2), a passageway (3) held upright by a hanging member (4), and an apron (5), the passageway comprising a proximal hole (6) and a distal hole (7), wherein the apron is adapted to receive insects and is attached to the proximal hole and the distal hole defines an entry into the chamber and is adapted to allow the insects to enter the chamber, wherein the proximal hole has a longest cross-diameter that is larger than the longest cross-diameter of the distal hole.

In certain embodiments, the a trapping chamber has a height, e.g., from about 6 inches to about 18 inches, from about 9 inches to about 15 inches or about 12 inches. In certain embodiments, the distal hole of the passageway has a diameter, e.g., from about 0.5 inches to about 3 inches, about 1 inch to about 2 inches or about 1.5 inches. In certain embodiments, the proximal hole of the passageway has a diameter, e.g., from about 5 inches to about 15 inches, about 7 inches to about 12 inches or about 9 inches. In certain embodiments, the height and width of the apron are each independent, e.g., from about 6 inches to about 30 inches or about 8 inches to about 25 inches or about 10 inches to about 20 inches.

In certain embodiments, one or more of the trapping chamber, the passageway and the apron comprises a mesh material, a plastic material or other bendable conforming material. In certain embodiments, a frame (e.g. made of plastic, metal or wood) defines one or more of the sections. In other embodiments, the trap is frameless.

In certain embodiments, the passageway is funnel-shaped.

In certain embodiments, the chamber is cylindrical or spherical.

In certain embodiments, the chamber has one flat side to conform to a tree or other outdoor structure.

In certain embodiments, the apron is conformable.

In certain embodiments, the apron has a flat portion.

In certain embodiments, the trap further comprising a hanging member such as a hook, loop, nail or other mechanism. This helps the trap to hang from or be affixed to a tree or other object or structure. In other embodiments, the hanging member can be a string, wire, cord, thread or line. In certain embodiments, the hanging member (e.g., string) can be attached internally to passageway (e.g., the narrow end of a funnel type passageway) and weave up though the device to the top of the trap. This helps the passageway stay upright without falling when the hanging member is attached to an object.

In certain embodiments, the hanging member is attached to the trapping chamber distal to the apron.

In certain embodiments, the trap does not comprise bait. In other embodiments, a bait can be used in one or more the chamber, the passageway or the apron. The bait can be, e.g., a food substance or a phenome.

In certain embodiments, the trap is openable in order to dispose of insects and the trap is reusable. The opening can be anywhere to access the trapping chamber and is closable with, e.g., the hanging member, a zipper, button, hook and loop device or other mechanism. In other embodiments, the trap is permanently sealed and disposable.

In certain embodiments, the trap is made of a material (e.g., mesh) that is bendable or foldable such that the trap can fold or collapse (e.g. for ease in shipment).

In certain embodiments, insects targeted by the trap can be a spotted lanternfly. In other embodiments, the insect can be aphids, corn earworms, Japanese beetles, stink bugs, beetles such as click beetles or Colorado potato beetles, cabbage loopers, bees, cicadas, or moths such as diamondback moths.

In certain embodiments, the invention is directed to a method of trapping an insect with a trap as disclosed herein.

The trap may be hung outside and affixed to a natural object (e.g., a tree) or manufactured structure (e.g., a dwelling, fence or post). The apron may be affixed to the structure such that an insect on the structure comes into contact with the apron. In certain embodiments, the trap is positioned such that the apron is below the chamber to maximize catching insects as they walk vertically up from the earth.

What is claimed is:

1. A trap for catching insects comprising
a trapping chamber,
a funnel-shaped passageway comprising a proximal hole and a distal hole and a conformable apron for contacting insects,
wherein the apron is attached to the proximal hole of the passageway,
wherein the distal hole of the passageway defines an entry for insects into the chamber,
wherein the proximal hole has a longest cross-diameter that is larger than the longest cross-diameter of the distal hole.

2. The trap of claim 1, wherein one or more of: the trapping chamber, the passageway and the apron comprises a mesh material.

3. (canceled)

4. The trap of claim 1, wherein the chamber is cylindrical or spherical.

5. The trap of claim 1, wherein the chamber is flat on one side.

6. (canceled)

7. The trap of claim 1, wherein the apron has a flat portion.

8. The trap of claim 1, further comprising a hanging member.

9. The trap of claim 8 7, wherein the hanging member is attached to the trapping chamber distal to the apron.

10. The trap of claim 1, that does not comprise bait.

11. (canceled)

12. A method of trapping an insect comprising affixing a trap on a natural or manufactured structure, the trap comprising
a trapping chamber,
a funnel-shaped passageway comprising a proximal hole and a distal hole and a conformable apron for contacting insects,
wherein the apron is attached to the proximal hole of the passageway,
wherein the distal hole of the passageway defines an entry for insects into the chamber, wherein the proximal hole has a longest cross-diameter that is larger than the longest cross-diameter of the distal hole.

13. The method of claim 12, wherein one or more of: the trapping chamber, the passageway and the apron comprises a mesh material.

14. (canceled)

15. The method of claim 12 11, wherein the chamber is cylindrical or spherical.

16. The method of claim 12, wherein the chamber is flat on one side.

17. (canceled)

18. The method of claim 12, wherein the apron is has a flat portion.

19. The method of claim 12, further comprising a hanging member.

20. The method of claim 19, wherein the hanging member is attached to the trapping chamber distal to the apron.

21. The method of claim 12, wherein the trap is affixed to a tree.
